(19) United States
(12) Patent Application Publication
(10) Pub. No.: US 2011/0008083 A1
(43) Pub. Date: Jan. 13, 2011

(54) IMAGE HEATING APPARATUS

(75) Inventor: Osamu Okamoto, Moriya-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/821,410

(22) Filed: Jun. 23, 2010

(30) Foreign Application Priority Data
Jul. 9, 2009 (JP) 2009-162395

(51) Int. Cl. G03G 15/20

(52) U.S. Cl. 399/329

(57) ABSTRACT

An image heating apparatus includes a rotatable member; a belt member contactable to the rotatable member; a pressing member for pressing the belt member against the rotatable member to form a nip in which a recording material is nipped and conveyed; and a sheet member for covering a pressing surface of the pressing member at which the pressing member presses the belt member. The sheet member is mounted on the pressing member so as to have a first area in which an end portion thereof is located outside an end portion of the belt member with respect to a widthwise direction perpendicular to a conveying direction of the recording material and which includes a portion opposing the pressing surface, and so as to have a second area in which the end portion thereof is located inside the end portion of the belt member with respect to the widthwise direction.

### FIELD OF THE INVENTION AND RELATED ART

The present invention relates to an image heating apparatus in which a lubricant is applied onto an inner surface of a belt member supported by a supporting member and an image on a recording material is heated.

As the image heating apparatus, it is possible to use, e.g., a fixing apparatus (fixing device) for fixing a transferred unfixed image on a recording medium (member) or a glossiness-increasing apparatus for increasing glossiness of the image fixed on the recording material under application of heat and pressure.

As a conventional constitution of the image heating apparatus for fixing the transferred unfixed image on the recording material, a constitution in which the unfixed image was fixed on the recording material at a press-contact portion (in a nip) created by causing a belt conveying device as shown in FIGS. 6(a) and 6(b) to press-contact a heating roller including a heat source has been known.

In the belt conveying device shown in FIGS. 6(a) and 6(b), a belt member 13 is stretched around a pressing roller 14 and a tension roller 15 and a pressing pad 18 presses the inner surface of the belt member 13 so that the belt member 13 is pressed against a heating roller (not shown) to create the nip. Further, between the pressing pad 18 for creating the nip and the tension roller 15, as disclosed in Japanese Laid-Open Patent Application (JP-A) Hei 11-045018, an oil application roller 16 for applying oil onto the inner surface of the belt member 13 is disposed. By applying the oil in a proper amount onto the inner surface of the belt member 13 in advance, a frictional resistance between the pressing pad 18 and the belt member 13 is decreased.

The oil supplied to the inner surface of the belt member 13 is also supplied to the pressing roller 14 and the tension roller 15 through the inner surface of the belt member 13.

The pressing pad 18 is constituted by three members of a pad holder 18A, a pad rubber 18B and a low friction sheet 18C. Of these members, the low friction sheet 18C is provided for decreasing the frictional resistance between the pad rubber 18B and the belt member 13 or the pressing roller 14. Further, the low friction sheet 18C prevents the oil applied onto the inner surface of the belt member 13 from contacting the pad rubber 18B, so that a desired nip distribution is not impaired by swelling or the like of the pad rubber 18B. For this reason, in order to prevent the oil from entering the pad rubber 18B, the low friction sheet 18C is longer than the belt member 13 with respect to a roller axis (shaft) direction.

However, an oil O supplied to the pressing roller 14 through the inner surface of the belt member 13 is partly removed and remains at a portion (contact portion) where the pressing roller 14 starts the contact with the pressing pad 18. Further, the oil O applied onto the inner surface of the belt member 13 is partly removed and remains at a portion (contact portion) where the belt member 13 starts the contact with the pressing pad 18.

Then, the oil remaining at the contact portions as described above moves along the low friction sheet 18C longer than the belt member 13 with respect to the axial direction and is discharged to the outside of the belt member 13. Then the oil discharged to the outside of the belt member 13 is discharged to the outside of the fixing device through the end portion of the low friction sheet 18C as shown in FIG. 6(b).

Therefore, an amount of the discharged oil is gradually increased with a lapse of an operating time of the fixing device, so that an amount of the oil on the inner surface of the belt member is lowered. As a result, the fixing device is accompanied with a problem of durability.

### SUMMARY OF THE INVENTION

A principal object of the present invention is to provide an image heating apparatus capable of suppressing a lowering in amount of a lubricant on an inner surface of a belt member.

According to an aspect of the present invention, there is provided an image heating apparatus comprising:

a rotatable member;

a belt member contactable to the rotatable member;

a pressing member for pressing the belt member against the rotatable member to form a nip in which a recording material is nipped and conveyed; and

a sheet member for covering a pressing surface of the pressing member at which the pressing member presses the belt member,

wherein the sheet member is mounted on the pressing member so as to have a first area in which an end portion thereof is located outside an end portion of the belt member with respect to a widthwise direction perpendicular to a conveying direction of the recording material and which includes a portion opposing the pressing surface, and so as to have a second area in which the end portion thereof is located inside the end portion of the belt member with respect to the widthwise direction.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1(a) is a sectional view of a fixing apparatus (fixing device), and FIG. 1(b) is a front view of the fixing device.

FIG. 2 is a perspective view of the fixing device.

FIGS. 3(a) and 3(b) are schematic views for illustrating a belt member, a photosensitive drum and an oil circulatory path.

FIG. 4(a) is a sectional view of the pressing pad, and FIG. 4(b) is an enlarged view of a main part of the pressing pad for illustrating a length relationship of the pressing pad.

FIG. 5 is a schematic sectional view of an image forming apparatus.

FIG. 6(a) is a sectional view showing a stagnant oil position in a conventional fixing device, and FIG. 6(b) is a perspective view showing a belt member, a pressing pad and an oil circulatory path in the conventional fixing device.

### DESCRIPTION OF THE PREFERRED EMBODIMENTS

Hereinbelow, with reference to the drawings, embodiments of the present invention will be described. However, dimensions, materials, shapes, and relative arrangements, and the like of constituent elements described in the following embodiments may be appropriately be changed depending on constitutions and various conditions for apparatuses or devices to which the present invention is applied. Therefore, it should be understood that the present invention is not limited to those specifically described in the following embodiments unless otherwise noted specifically.

Further, in the following description, a belt conveying device rotating in press-contact with a roller is exemplified but the present invention is not limited thereto. For example, it is also possible to use the belt conveying device rotating in press-contact with a drum-like member covered with film and the belt conveying device of a twin belt type in which two belts rotate in press-contact with each other.

Hereinafter, the image forming apparatus as the belt conveying device and the image forming apparatus including the image heating apparatus will be described as an example. In the following, a belt(-type) fixing device for fixing an unfixed image on a recording material is exemplified but the present invention is not limited thereto. For example, other image heating apparatuses such as a glossiness-increasing apparatus for increasing a glossiness of the image by heating the image fixed on the recording material.

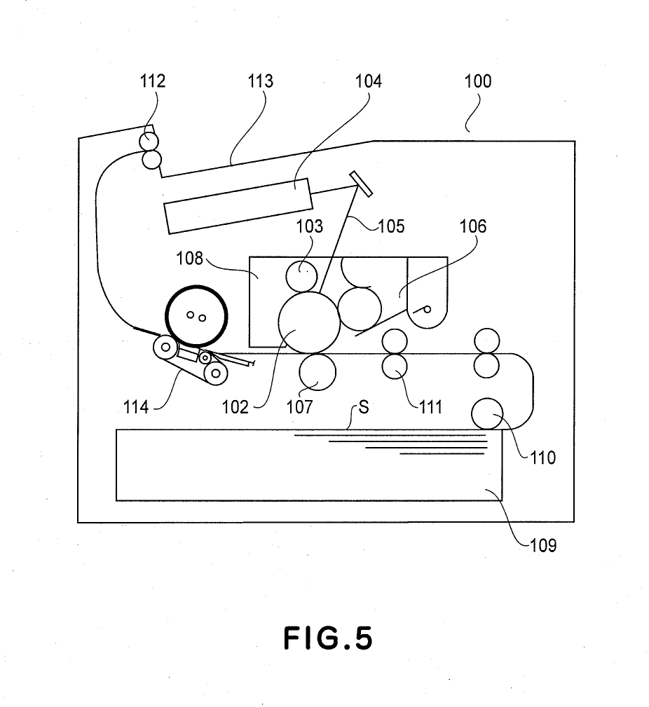

First, with reference to FIG. 5, a general structure of the image forming apparatus including the belt fixing device will be described. FIG. 5 is a longitudinal sectional view showing a schematic structure of the image forming apparatus of an electrophotographic type (so-called printer) as an example of the image forming apparatus including the belt fixing device.

As shown in FIG. 5, parts of an image forming apparatus 100 are roughly classified into an image forming means for forming a toner image on a sheet as the recording material and the belt fixing device as the image heating apparatus for fixing an unfixed toner image formed on the sheet under application of heat and pressure.

First, the image forming means will be described. The image forming means includes the following devices or means. A charger 103 as a charging means is provided opposed to a photosensitive drum 102 as an image bearing member and electrically charges the surface of the photosensitive drum 102 uniformly. The surface of the photosensitive drum 102 is exposed to light 105, depending on the image, emitted from an exposure device 104 as an exposure means, so that an electrostatic latent image is formed on the photosensitive drum 102. The electrostatic latent image is developed by a developing device 106 as a developing means, so that a toner image is formed on the photosensitive drum 102. On the other hand, a sheet S is accommodated in a sheet feeding cassette 109 disposed at a lower portion of the image forming apparatus 100 and is fed one by one by a sheet feeding roller 110. Then, the sheet S is conveyed by a registration roller pair 111 as a conveying means while being timed to the toner image on the photosensitive drum 102. The toner image on the photosensitive drum 102 is electrostatically transferred onto the sheet S by a transfer roller 107 as a transfer means. After the transfer, the toner remaining on the photosensitive drum 102 is removed by a cleaning device 108 as a cleaning means.

The sheet S on which the toner image has been transferred as described above is conveyed to a fixing device 114. Then, the toner image formed on the sheet S by the image forming means is fixed on the sheet S by being heated and pressed in the fixing device 114 as the image heating apparatus. Thereafter, the sheet S on which the toner image is fixed is conveyed to a discharging roller pair 112 by which the sheet S is discharged onto a discharging tray 113 provided at an upper portion of the image forming apparatus 100.

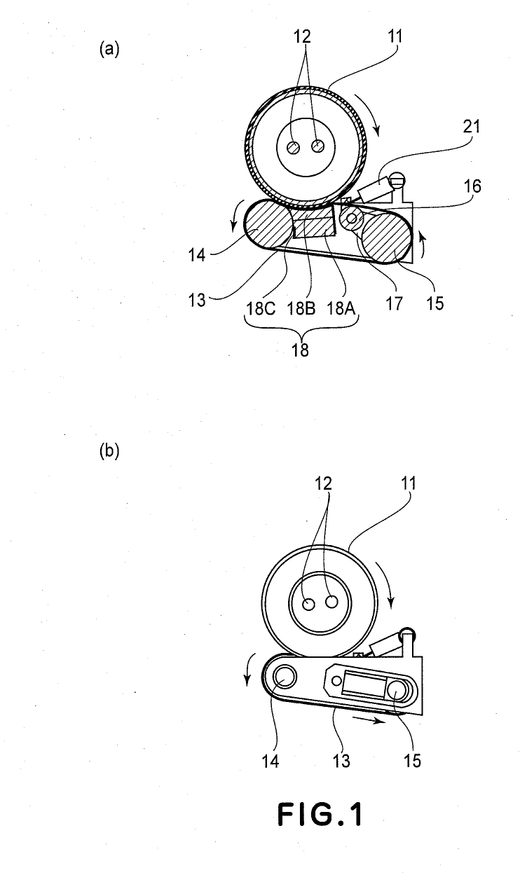

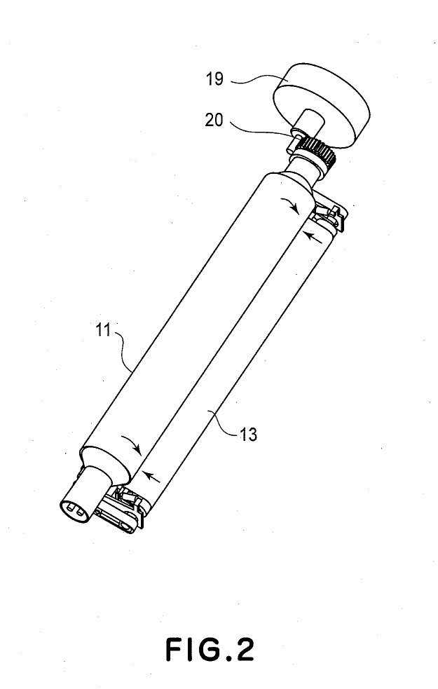

Next, the fixing device as the belt conveying device will be described with reference to FIGS. 1(a) and 1(b) and FIG. 2. FIGS. 1(a) and 1(b) illustrate a basic structure of the fixing device, in which FIG. 1(a) is a sectional view of the fixing device and FIG. 1(b) is a front view of the fixing device. FIG. 2 is a perspective view of the fixing device.

As shown in FIGS. 1(a), 1(b) and 2, the fixing device 114 includes a heating roller 11 as a rotatable member containing a halogen heater 12 therein. The heating roller 11 is the rotatable member for fixation provided for applying heat generated by the inner halogen heater 12 to the toner on the sheet and for conveying the sheet together with the belt member 13. The heating roller 11 is rotationally driven by a driving force transmitted from a motor 19 thereto through a gear 20.

The belt conveying device as a rotatable pressing member press-contacts the heating roller 11. The belt conveying device includes the belt member 13, the pressing roller 14 and the tension roller 14 which are a stretching (supporting) member, the pressing pad 18 as the pressing member and the oil application roller 16 as a lubricant application member. The belt member 13 is stretched around and supported by the pressing roller 14 as the rotatable pressing member and the tension roller 15 having the function of imparting a belt tension, with a predetermined tension (e.g., 100N). In this embodiment, as the stretching (supporting) member for stretching (supporting) the belt member 13, the rollers (the pressing roller 14 and the tension roller 15) are used but the present invention is not limited thereto. Other stretching members may also be employed so long as the stretching members can stretch the belt member.

The heating roller 11 includes, e.g., a metal core consisting of a cylindrical aluminum pipe having an outer diameter of 56 mm and an inner diameter of 50 mm and includes the heater 12 in the metal core. The heating roller 11 further includes an elastic layer of a silicone rubber having, e.g., a thickness of 2 mm and an ASKER-C hardness of 45 degrees on the surface of the metal core and includes a heat resistive parting layer of PFA or PTFE as a surface layer on the elastic layer.

The belt member 13 and the heating roller 11 are rotated at a predetermined peripheral speed (210 mm/sec in this embodiment) during sheet conveyance.

As a material for the belt member 13, any material may be appropriately selected and used so long as the material has heat resistivity. For example, the belt member 13 may be prepared by coating a 300 μm-thick silicone rubber on a 75 μm-thick polyimide film having a width of 380 mm and a circumferential length of 200 mm.

The pressing roller 14 is the stretching member (roller), for stretching the belt member 13, formed with, e.g., a hollow stainless steel member having an outer diameter of 20 mm. The pressing roller 14 is disposed on an exit side of the nip area (press-contact area) between the pressing roller 11 and the belt member 13 with respect to the conveying direction and elastically deforms the elastic layer of the pressing roller 11 in a predetermined amount.

The tension roller 15 is, e.g., a hollow roller of stainless steel formed in an outer diameter of about 20 mm and an inner diameter of about 18 mm and functions as the belt stretching (supporting) roller (stretching (supporting) member).

The pressing pad 18 is such a pressing member that it surface-contacts the inner surface of the belt member 13 (at a contact surface 18E) to press the belt member 13 and also contacts the pressing roller 14. The pressing pad 18 press-contacts the belt member 13 against the pressing roller 11 to create the nip together with the pressing roller 14. Here, the contact surface means a pressing surface at which the pressing pad 18 presses the belt member 13 against the heating roller 11.

Between the pressing pad 18 and the tension roller 15, the oil application roller (lubricant application member) 16 for applying the lubricant onto the inner surface of the belt member 13 is disposed. The oil application roller is rotatably supported about the rotation axis of the tension roller 15 by a rotatably supported arm 17 and is caused to press-contacts the inner surface of the belt member 13 by a spring 21.

The oil application roller 16 is formed with a sheet-like oil application contact film including a heat resistive aramid felt impregnated with a heat resistive silicone oil having a viscosity of about 1000 CS and a porous PTFE layer provided on the surface layer of the aramid felt. The oil application roller 16 supplies (applies) the heat resistive silicone oil as the lubricant to the inner surface of the belt member 13. The viscosity of the heat resistive silicone oil in this embodiment is about 1000 CS but may appropriately be set depending on an operation condition. However, in the case where a low-viscosity oil having the viscosity of 100 CS or less is used, oil holding power by the heat resistive aramid felt is lowered, so that the oil is released in a short time. As a result, the oil on the inner surface of the belt member 13 becomes excessive and the excessive oil is discharged to the outside of the fixing device, so that stable belt conveyance cannot be performed for a long time. Further, in the case where the oil having the viscosity of 500,000 CS or more is used, the oil holding power is increased, so that not only stable oil supply is impaired but also sliding resistance between the belt member 13 and the pressing pad 18 becomes large. As a result, the stable belt conveyance also cannot be performed.

The heat resistive silicone oil supplied onto the inner surface of the belt member 13 is also supplied to the surfaces of the pressing roller 11 and the tension roller 15 through the inner surface of the belt member 13.

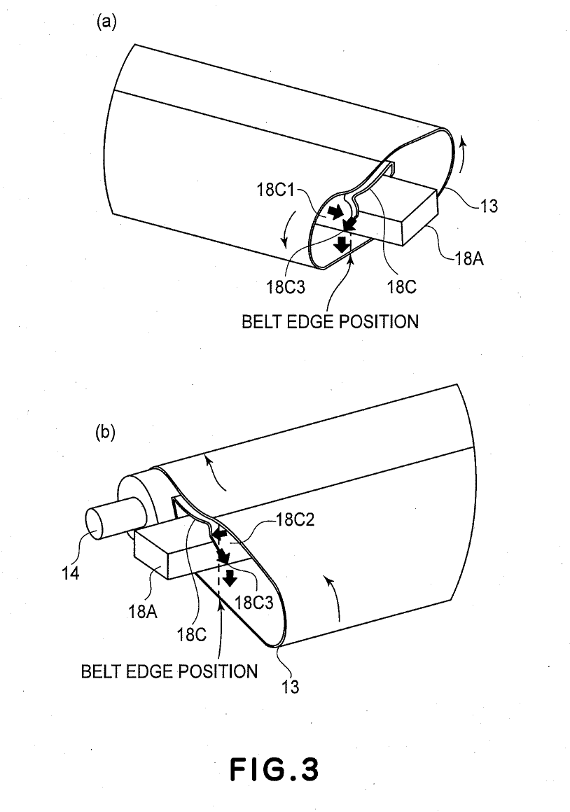

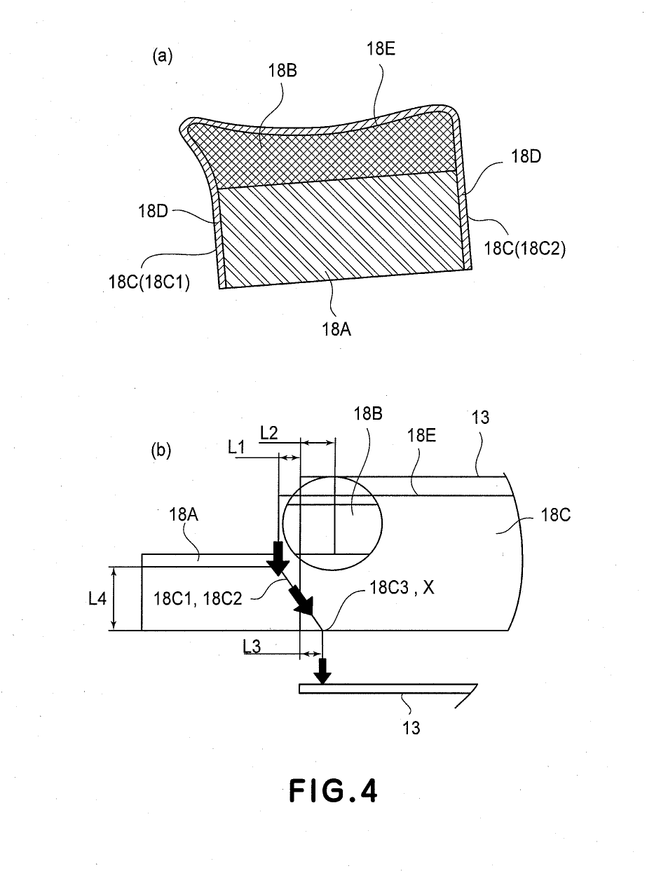

Then, with reference to FIGS. 3(a), 3(b), 4(a) and 4(b), the pressing pad 18 will be described more specifically. FIGS. 3(a) and 3(b) are perspective views each showing the belt member, the pressing pad and the oil circulatory path. FIG. 4(a) is a sectional view of the pressing pad, and FIG. 4(b) is an enlarged view of a main part of the pressing pad for illustrating a length relationship of the pressing pad. Incidentally, in FIG. 3(a), the rollers 14 and 15 are omitted. In FIG. 3(b), the rollers 15 and 16 are omitted.

As shown in FIGS. 4(a) and 4(b), the pressing pad 18 is constituted by three members of the pad holder 18A, the pad rubber 18B and the low friction sheet 18C.

The pad holder 18A is formed of SUS (stainless steel) in order to satisfy a strength for permitting nip creation. The pad rubber 18B is formed with an elastic member of silicone rubber or the like formed on the pad holder 18A in order to uniformize a nip pressure distribution. The low friction sheet 18C as the sheet member is provided in order to decrease the friction resistance between the pad rubber 18B and the belt member 13 or the pressing roller 14.

As shown in FIG. 4(a), the low friction sheet 18C is fixed on a side surface (fixed surface 18D) of the pad holder 18A so as to cover the entire side surface of the pad holder 18A and the entire side and upper surfaces of the pad rubber 18B.

Here, the low friction sheet 18C may appropriately be selected from members so long as the selected member possesses a surface sliding property and the heat resistivity. As the low friction sheet 18C, e.g., a 50 μm-thick polyimide film on which a 10 μm-thick PTFE layer is coated on its sliding surface side where the low friction sheet 18C slides on the belt member 13 is used.

The low friction sheet 18C decreases, as described above, the friction resistance between itself and the belt member 13 or the pressing roller 14. Further, the low friction sheet 18C prevents the oil applied onto the inner surface of the belt member 13 from contacting the pad rubber 18B to impair a desired nip pressure distribution by swelling or the like of the pad rubber 18B. For that reason, as shown in FIGS. 4(a) and 4(b), the low friction sheet 18C has a length longer than that of the belt member 13 with respect to a widthwise direction thereof perpendicular to a rotational direction of the belt member 13 at the contact surface between the low friction sheet 18C and the belt member 13. The widthwise direction of the low friction sheet 18C is also a direction perpendicular to the conveying direction of the recording material. In this embodiment, the low friction sheet 18C is longer than the belt member 13 by a length L1 (3 mm) in the area in which the low friction sheet 18C contacts the pad rubber 18B. Further, as shown in FIG. 4(b), the belt member 13 is longer than the pad rubber 18B by a length L2 (4 mm in this embodiment) with respect to the widthwise direction. Accordingly, the low friction sheet 18C is longer than not only the belt member 13 but also the pad rubber 18B with respect to the widthwise direction. Based on such a length relationship, at the contact surface, the low friction sheet 18C has an area (first area) such that both ends thereof are located outside those of the belt member 13.

The low friction sheet 18C includes non-contact portions 18C1 and 18C2 spaced downward from the belt member 13 on upstream and downstream sides with respect to the rotational direction of the belt member 13. The non-contact portions 18C1 and 18C2 are located below the nip with respect to a vertical direction of the fixing device (image heating apparatus).

The lengths of the non-contact portions 1801 and 18C2 of the low friction sheet 18C are shorter than the length of the belt member 13 at the contact surface 18E with respect to the widthwise direction. Further, the low friction sheet 18C includes side surface lower end portions 18C3, of the non-contact portions 18C1 and 18C2, which are located inside the end of the belt member 13. Specifically, the end surface of the low friction sheet 18C with respect to the widthwise direction is partly cut obliquely toward the inside of the belt member 13 at a portion where the non-contact portion 18C1 and 18C2 do not contact the pad rubber 18B, so that the end surface lower end 18C3 of the low friction sheet 18C enters the inside of the belt member 13 by a length L3 with respect to the widthwise direction. In this embodiment, the end surface lower end (side surface lower end portion 18C3) of the low friction sheet 18C has a shape such that it enters the inside of the belt member 13 by 3 mm (L3) with respect to the widthwise direction of the belt member 13. The obliquely cut portion of the low friction sheet 18C has the length of L1+L3 (6 mm in this embodiment) with respect to the widthwise direction of the belt member 13 and a length L4 (8 mm in this embodiment) with respect to a direction perpendicular to the widthwise direction. Based on such a length relationship, the low friction sheet 18C has an area (second area) such that both ends of the low friction sheet 18C are located inside those of the belt member 13 at the non-contact portions. Incidentally, in this embodiment, a constitution in which the both ends of the low friction sheet 18C are located inside those of the belt member 13 is employed but, also in a constitution in which only one of the both ends of the low friction sheet 18C is located inside the associated end of the belt member 13, it is possible to suppress the lowering in amount of the lubricant.

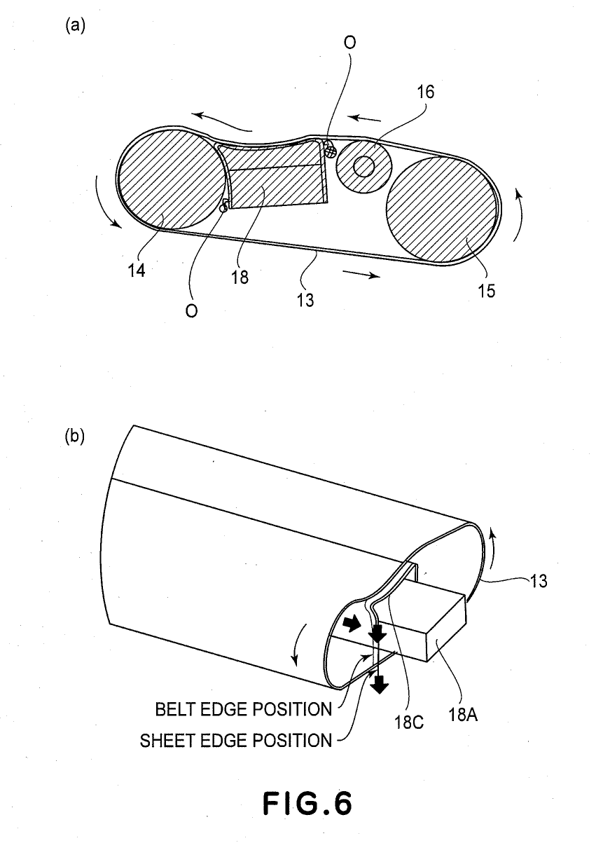

The oil O applied onto the inner surface of the belt member 13 is, as shown in FIG. 6(a), partly removed and remains at a portion (contact portion) where the belt member 13 starts the contact with the pressing pad 18 on the downstream side of the pressing pad 18 with respect to the belt rotational direction. The oil remaining at the contact portion in this way moves along the low friction sheet 18C longer than the belt member 13 with respect to the axial direction and is then discharged from the end of the belt member to the outside of the belt member 13. The oil discharged to the outside of the belt member 13 moves, as shown in FIG. 3(b), along the end surface edge of the obliquely cut portion (inclined portion) of the low friction sheet 18C and drops from a position X (the lower end of the obliquely cut portion) shown in FIG. 4(b) toward the inner surface of the belt member 13 located below the low friction sheet 18C. As described above, the position X (the side surface lower end portion 18C3) is located 3 mm inside the end of the belt member 13, so that the dropped outside is returned on the inner surface of the belt member 13.

As a result, the oil once discharged from the above-described contact portion to the outside of the belt member 13 along the low friction sheet can be returned on the inner surface of the belt member 13. Therefore, the heat resistive silicone oil as the lubricant can be retained on the inner surface of the belt member 13 for a long time, so that the belt member 13 can be rotated stably for a long time. Thus, it becomes possible to realize service life extension of the belt inner surface lubricant and prevention of image defect and apparatus contamination due to the discharge of the lubricant to the outside of the fixing device.

Further, with respect to the low friction sheet 18C, the upstream-side non-contact portion 18C1 spaced from the belt member 13 contacts an upstream portion of the pressing roller 14 with respect to the rotational direction of the pressing roller 14 in an area in which the pressing roller 14 does not contact the belt member 13. As described above, the non-contact portion 18C1 of the low friction sheet 18C is shorter than the belt member 13 with respect to the widthwise direction at the contact surface 18E at which the low friction sheet 18C contacts the belt member 13, and the side surface lower end portion 18C3 of the non-contact portion 18C1 is located inside the end of the belt member 13 with respect to the widthwise direction. Further, with respect to the low friction sheet 18C, the lower end portion of the non-contact portion 18C1 is spaced from the pressing roller 14 and is located below the contact portion at which the low friction sheet 18C contacts the pressing roller 14 (FIG. 1(a)). For that reason, even when the oil stagnates at a portion (contact portion) where the low friction sheet 18C starts the contact with the pressing roller, the oil moves downward along the end surface edge of the obliquely cut surface of the low friction sheet 18C by gravitation and is returned on the inner surface of the belt member 13.

As a result, it becomes possible to return the oil, once discharged from the above-described contact portion to the outside of the belt member 13 along the low friction sheet 18C, to the inner surface of the belt member 13. Therefore, the heat resistive silicone oil as the lubricant can be retained on the inner surface of the belt member 13 for a long time and the belt member 13 can be stably rotated for a long time. Accordingly, it is possible to realize the service life extension of the belt inner surface lubricant and prevention of the image defect and the apparatus contamination due to the discharge of the lubricant to the outside of the fixing device.

Incidentally, in the above-described embodiment, of the rotatable member for the fixation and the rotatable member for the pressing which constitution the belt fixing device, the rotatable member for the pressing (one of the rotatable members) is described as the belt conveying device but the constitution of the present invention is not limited thereto. For example, it is also possible to employ a constitution in which the rotatable member for the fixation (the other rotatable member) is the belt conveying device or a constitution in which both of the rotatable members are the belt conveying device. A similar effect can be obtained by applying the present invention to these belt conveying devices.

Further, in the above-described embodiment as the image heating apparatus, the fixing device for fixing the toner image on the recording material is exemplified but the present invention is not limited thereto. For example, as another example, the glossiness-increasing apparatus (device) for increasing the glossiness of the image by heating the toner image fixed on the recording material can be exemplified.

Further, in the above-described embodiment, the printer is exemplified as the image forming apparatus but the present invention is not limited thereto. For example, other image forming apparatuses such as a copying machine, a facsimile machine, a multi-function machine having a combination of the functions of the above-described machines may also be used as the image forming apparatus in the present invention. Further, in the present invention, the image forming apparatus in which a recording material conveying member (conveyer belt) is used and respective color toner images are successively transferred onto the recording material carried on the recording material conveying member may also be employed. It is also possible to employ the image forming apparatus in which an intermediary transfer member (intermediary transfer belt) is used and the respective color toner images are successively transferred onto the intermediary transfer member and then are collectively transferred from the intermediary transfer member onto the recording material. By applying the present invention to the belt conveying device used in these image forming apparatuses, a similar effect can be achieved.

Further, in the above-described embodiment, the belt conveying device in the image forming apparatus is exemplified but the present invention is not limited thereto. The present invention is also applicable to the belt conveying device for decreasing the friction resistance between the belt member and the belt sliding surface by applying the lubricant onto the inner surface of the belt member.

According to the present invention, the lubricant remaining at the contact portion between the sheet member and the belt member is once discharged from the end of the belt member to the outside of the belt member but is returned to the inner surface of the belt member along the end portion edge of the sheet member. By such a simple constitution, it is possible to provide the belt conveying device capable of preventing the lubricant on the inner surface of the belt member from being discharged to the outside of the belt member to be lowered in amount of the lubricant on the inner surface of the belt member and capable of realizing excellent durability and less occurrences of the image defect and the apparatus contamination due to the discharge of the lubricant.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 162395/2009 filed Jul. 9, 2009, which is hereby incorporated by reference.

What is claimed is:

1. An image heating apparatus comprising:
a rotatable member;
a belt member contactable to said rotatable member;
a pressing member for pressing said belt member against said rotatable member to form a nip in which a recording material is nipped and conveyed; and
a sheet member for covering a pressing surface of said pressing member at which said pressing member presses said belt member,
wherein said sheet member is mounted on said pressing member so as to have a first area in which an end portion thereof is located outside an end portion of said belt member with respect to a widthwise direction perpendicular to a conveying direction of the recording material and which includes a portion opposing the pressing surface, and so as to have a second area in which the end portion thereof is located inside the end portion of said belt member with respect to the widthwise direction.

2. An apparatus according to claim 1, wherein the end portion of said sheet member is located inside the end portion of said belt member with respect to the widthwise direction at a lower position of said belt member opposite from an upper position of said belt member opposing the nip with respect to a vertical direction.

3. An apparatus according to claim 1, wherein said sheet member includes an inclined portion at which the end portion of said sheet member ranges from an outside of said belt member toward and inside of said belt member.

4. An apparatus according to claim 1, wherein at the pressing surface, each of end portions of said sheet member is disposed outside an associated end portion of said belt member.

5. An apparatus according to claim 1, wherein in the second area, each of end portions of said sheet member is disposed inside an associated end portion of said belt member.

6. An image heating apparatus comprising:
a rotatable member;
a belt member contactable to said rotatable member;
a pressing member for pressing said belt member against said rotatable member to form a nip in which a recording material is nipped and conveyed; and
a sheet member for covering a pressing surface of said pressing member at which said pressing member presses said belt member,
wherein said sheet member is mounted on said pressing member so as to have a first area in which a length thereof is longer than a length of said belt member with respect to a widthwise direction perpendicular to a conveying direction of the recording material and which includes a portion opposing the pressing surface, and so as to have a second area in which the length thereof is shorter than the length of said belt member with respect to the widthwise direction.

7. An apparatus according to claim 6, wherein the second area of said sheet member is located at a lower position of said belt member opposite from an upper position of said belt member opposing the nip with respect to a vertical direction.

8. An apparatus according to claim 6, wherein at the pressing surface, each of end portions of said sheet member is disposed outside an associated end portion of said belt member.

9. An apparatus according to claim 6, wherein in the second area, each of end portions of said sheet member is disposed inside an associated end portion of said belt member.
